(19) United States
(12) Patent Application Publication
(10) Pub. No.: US 2005/0286370 A1
(43) Pub. Date: Dec. 29, 2005

(54) Disk apparatus, information recording and reproducing method, and disk rotation speed control method

(75) Inventor: Yuzo Nishimura, Chiba (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 10/965,452

(22) Filed: Oct. 13, 2004

(30) Foreign Application Priority Data
Jun. 28, 2004 (JP) 2004-189585

(51) Int. Cl. G11B 5/09; G11B 15/52

(52) U.S. Cl. 369/47.36; 369/47.1

(57) ABSTRACT

A disk apparatus is provided capable of reducing the change in the rotational speed of the disk during a (block) replacement process and thereby ensuring that each (block) replacement operation can be quickly initiated. In a (block) replacement process, the disk apparatus determines whether the rotational speed of the disk set for the disk radial position of the defective block falls within a standard speed range, and based on the determination result, selects a speed from within the standard speed range and sets it as the rotational speed of the disk for the spare area so as to reduce the difference between the disk rotational speeds for the user data recording area and the spare area. Thus, the disk rotational speed control is performed differently for each area to reduce the change in the disk rotational speed and thereby ensure that each (block) replacement operation can be quickly initiated.

### CLAIM OF PRIORITY

The present application claims priority from Japanese application serial no. P2004-189585, filed on Jun. 28, 2004, the content of which is hereby incorporated by reference into this application.

### BACKGROUND OF THE INVENTION

1. Field of the Invention

The present invention relates to disk apparatuses such as optical disk apparatuses, and more particularly to a technique for controlling the disk rotational speed in a (block) replacement process.

2. Description of the Related Art

Japanese Patent Laid-Open No. 2-179970 (1990) discloses a prior art technique related to the present invention. This technique divides a disk-shaped information recording medium into a plurality of concentric annular zones, each including a plurality of tracks. Each zone is provided with a spare area and a spare area management area for managing the spare area. The rotational speed of the disk-shaped information recording medium is varied for each zone; a write or read operation is performed at a constant disk rotational speed if within the same zone. This technique does not change the rotational speed of the disk-shaped information recording medium during a (block) replacement process.

### SUMMARY OF THE INVENTION

The above prior art technique may be applied to only disk-shaped information recording media (hereinafter referred to simply as disks) which have a plurality of zones each including a spare area; this technique is difficult to apply to disks having spare areas along their innermost and outermost circumferences.

The present invention has been devised in view of the foregoing problem with the prior art technique. It is, therefore, an object of the present invention to provide a disk apparatus capable of quickly performing a write or read operation by using a novel technique for reducing the change in the disk rotational speed during a (block) replacement process and thereby ensuring that each (block) replacement operation can be quickly initiated, wherein the novel technique is effective not only when applied to disks having spare areas along their innermost and outermost circumferences, but also when applied to disks having a plurality of zones each including a spare area and the (block) replacement process is performed such that a defective block is replaced by a block in the spare area of a different zone.

To accomplish the above object, the present invention provides means for, in a (block) replacement process in a disk apparatus, determining whether the rotational speed of the disk set for the disk radial position of the defective block falls within the standard speed range set for a disk radial position in a spare area, and based on the determination result, selecting a speed from within the standard speed range and setting it as the rotational speed of the disk for the spare area so as to reduce the difference between the disk rotational speeds for the user data recording area and the spare area.

Specifically, the present invention proposes a disk apparatus including the above means (and satisfying the above requirement), and also proposes an information recording/reproducing method for a disk apparatus and a disk rotation speed control method.

A disk apparatus of the present invention can reduce the change in the disk rotational speed during a (block) replacement process, ensuring that each (block) replacement operation can be quickly initiated.

### BRIEF DESCRIPTION OF THE DRAWINGS

FIG. 1 is a diagram showing an exemplary configuration of a disk apparatus according to an embodiment of the present invention.

FIGS. 2(A) and 2(B) are diagrams illustrating a disk rotation control of the disk apparatus shown in FIG. 1 in a (block) replacement process.

FIG. 3 is a flowchart illustrating a (block) replacement process in the disk apparatus shown in FIG. 1.

### DETAILED DESCRIPTION OF THE PREFERRED EMBODIMENTS

A preferred embodiment of the present invention will be described below with reference to the accompanying drawings.

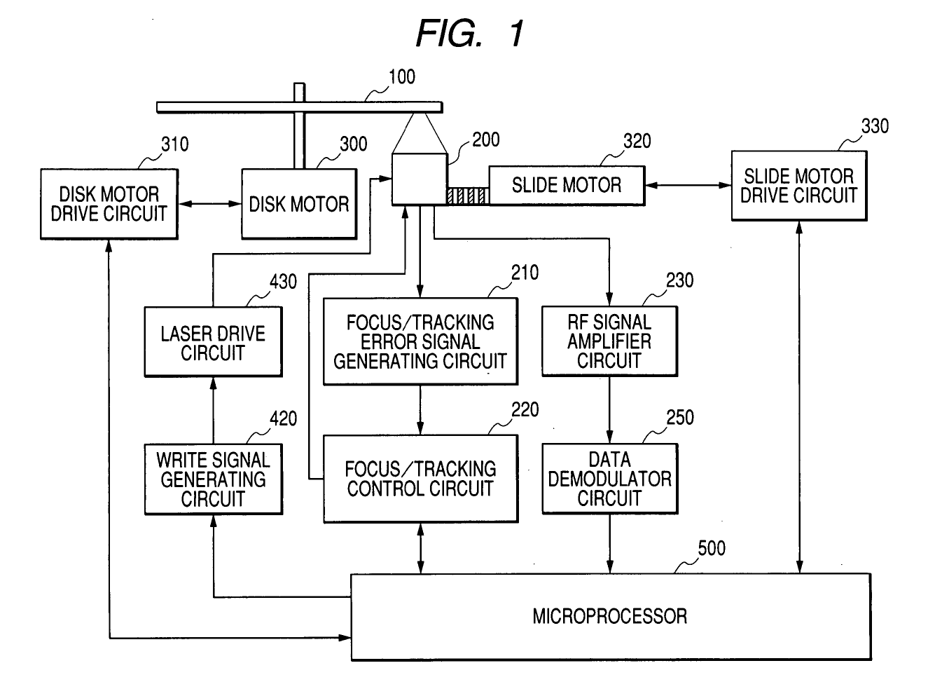

Referring to FIG. 1, reference numeral 100 denotes an optical disk such as DVD-RAM; 300, a disk motor for rotating the optical disk 100; 310, a disk motor drive circuit (or disk motor driving means) for driving the disk motor 300; 200, an optical pickup for irradiating the optical disk 100 with laser light and receiving the reflected laser light; 210, a focus/tracking error signal generating circuit for generating a focus error signal and a tracking error signal based on a signal reproduced by the optical pickup 200 from the reflected laser light; 220, a focus/tracking control circuit for generating a control signal based on the output of the focus/tracking error signal generating circuit 210 to control the objective lens (not shown) in the optical pickup 200; 430, a laser drive circuit for driving the laser diode in the optical pickup 200 based on a write signal; 420, a write signal generating circuit for generating the write signal; 230, an RF signal amplifier circuit for amplifying the RF signal reproduced by the optical pickup 200 from the reflected laser light; 250, a data demodulator circuit for demodulating the amplified RF signal; 320, a slide motor for moving the optical pickup 200 in a radial direction of the optical disk 100; 330, a slide motor drive circuit for controlling/driving the slide motor 320; and 500, a microprocessor (or control means) for controlling the disk motor drive circuit 310, the write signal generating circuit 420, the focus/tracking control circuit 220, and the slide motor drive circuit 330. The optical disk 100 has two spare areas along its innermost and outermost circumferences, respectively, and a user data recording area disposed between these spare areas.

With the above arrangement, user data (information) is written by moving the optical pickup 200 from the inner circumference side to the outer circumference side of the optical disk 100 in a double speed mode, for example. At that time, the optical disk 100 is rotated by the disk motor 300 at a constant linear velocity so that the information is written to the recording surface of the optical disk 100 at a constant write speed. The microprocessor 500 causes the disk motor 300 to rotate at a predetermined speed through the disk motor drive circuit 310.

In performing a write operation to the user data recording area in a double speed mode; for example, the disk apparatus reads blocks one or a plurality of blocks at a time after writing data to them and checks whether the read data is identical to the written data. If it is determined that they are not identical, the block is recognized as a defective block and the microprocessor 500 performs control for a (block) replacement process based on this recognition. Specifically, the microprocessor 500 determines whether the rotational speed of the optical disk set for the disk radial position of the defective block falls within the standard speed range set beforehand for a disk radial position in a spare area (one of the two spare areas provided along the outermost and innermost circumferences, respectively, of the optical disk). Then, the microprocessor 500 moves the optical pickup 200 to the spare area by use of the slide motor drive circuit 330 and the slide motor 320, and writes the data to the spare area (instead of to the defective block) and further writes the necessary system management information to the management area to assign the defective block to the spare area.

The microprocessor 500 selects a speed from within the above standard speed range based on the above determination result and sets it as the rotational speed of the optical disk 100 for the spare area. That is, if it is determined that the rotational speed of the optical disk 100 set for the disk radial position of the defective block falls within the above standard speed range, the microprocessor 500 sets the rotational speed of the optical disk 100 set for the disk radial position of the defective block as the rotational speed of the optical disk 100 for the spare area. If, on the other hand, the rotational speed of the optical disk 100 set for the disk radial position of the defective block does not fall within the above standard speed range, the microprocessor 500 selects the speed within the standard speed range closest to the rotational speed of the optical disk 100 set for the disk radial position of the defective block (that is, either the highest or lowest speed within the standard speed range, whichever is closest) and sets it as the rotational speed of the optical disk 100 for the spare area. The microprocessor 500 controls the disk motor drive circuit 310 so as to rotate the optical disk 100 at the set rotational speed by use of the disk motor 300. Thus, the rotational speed of the optical disk 100 for the spare area is set to at least a value within the above standard speed range, which makes it possible to reduce the difference between the rotational speeds of the optical disk 100 for the spare area and (for the disk radial position of the defective block in) the user data recording area and thereby reduce the change in the rotational speed of the optical disk 100 (during the block replacement process). This ensures that each (block) replacement operation can be quickly initiated. The microprocessor 500 performs control so as to write user data to the address in the spare area to which the defective block has been assigned while rotating the optical disk 100 at the rotational speed set for the spare area.

Upon completion of the user data write operation to the above address in the spare area, the microprocessor 500 moves the optical pickup 200 from the spare area to the disk radial position of the block next to the defective block in the user data recording area, and rotates the disk 100 at the rotational speed corresponding to this disk radial position. In this rotational state, the microprocessor 500 performs control so as to write user data to the above next block through the optical pickup 200. The disk apparatus of the present embodiment can also reduce the change in the rotational speed of the optical disk 100 due to this operation. That is, the present embodiment can reduce the difference between the rotational speeds of the optical disk 100 for the user data recording area and the spare areas. This allows quickly switching from a write operation in a spare area to that in the user data recording area.

It should be noted that in a read operation, the disk apparatus reads blocks in the user data recording area other than the defective blocks and further reads the blocks in the spare areas which have replaced the defective blocks, based on the above management information. This means that the read operation requires the same disk motor control as the write operation.

Specifically, in a write operation on the user data recording area and the spare areas, the laser diode (not shown) in the optical pickup 200 is driven by the laser drive circuit 430 based on the write signal generated from the write signal generating circuit 420 under control of the microprocessor 500. In a read operation on the user data recording area and the spare areas, on the other hand, the RF signal generated by the optical pickup 200 from the reflected laser light is processed by the RF signal amplifier circuit 230 and the data demodulator circuit 250. In both operations, the focus/tracking control circuit 220, together with the focus/tracking error signal generating circuit 210, performs focus/tracking control of the optical pickup 200.

Though not shown, the present embodiment is also effective when applied to a conventional disk configuration in which the user data recording area is divided into a plurality of zones each including a spare area. In such a case, when it is necessary to write to or read from a defective block in a zone, the defective block may be replaced by a block in the spare area of a different zone.

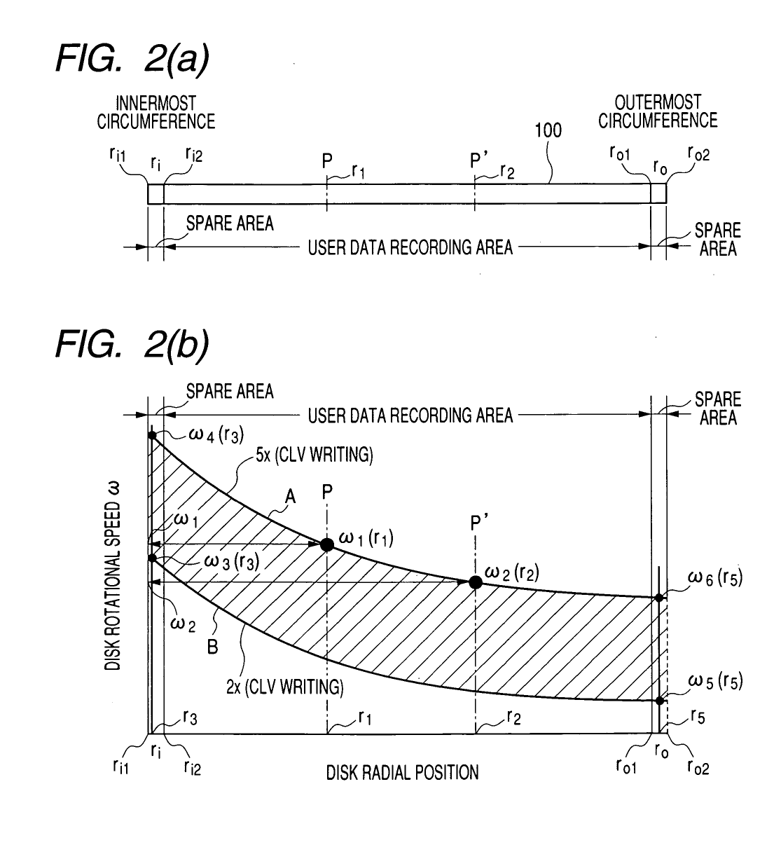

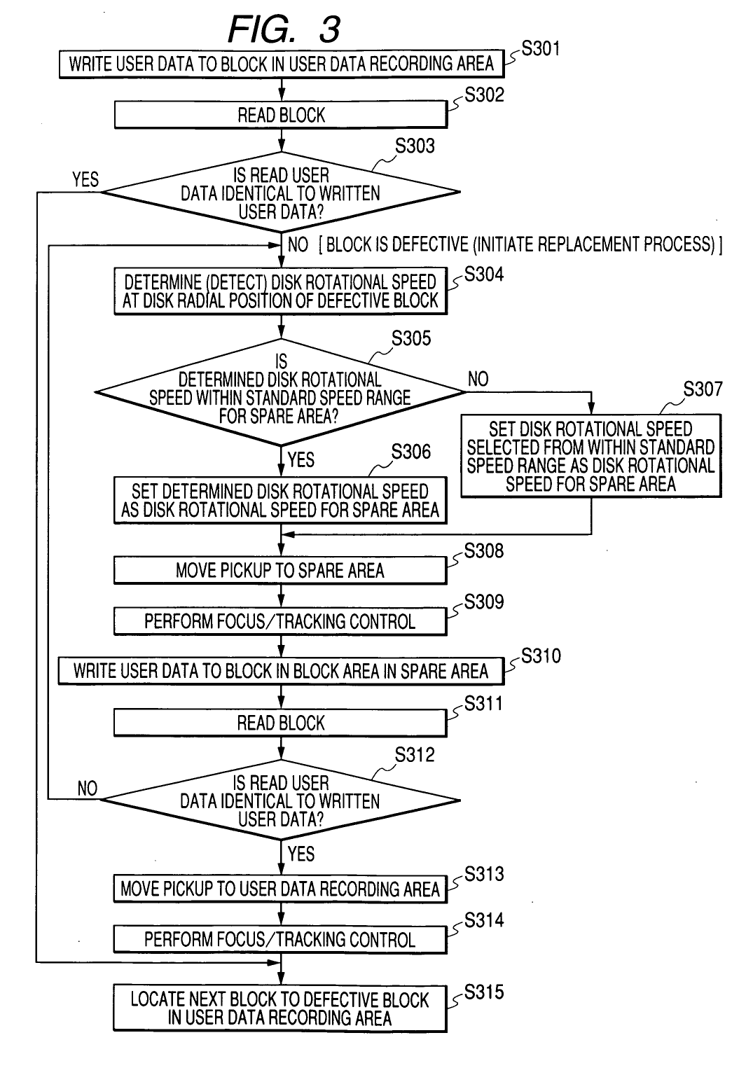

In FIGS. 2(A) and 2(B) and 3 described below, components which are the same as those in FIG. 1 are denoted by like numerals.

FIGS. 2(A) and 2(B) are diagrams illustrating a disk rotation control of the disk apparatus shown in FIG. 1 in a (block) replacement process. Specifically, FIGS. 2(A) and 2(B) show the disk rotation control carried out when information (user data) is written. It is assumed that the user data recording area and the spare areas can be set to any speed between 2× speed and 5× speed. Specifically, FIG. 2(A) is a cross-sectional view of the optical disk 100 taken in a radial direction, and FIG. 2(B) is a graph showing the relationship between the disk radial position and the rotational speed of the optical disk 100.

In FIGS. 2(A) and 2(B), the symbol A denotes the rotational speed characteristic of the optical disk 100 when data is written at a constant linear velocity corresponding to 5× speed; B, the rotational speed characteristic of the optical disk 100 when data is written at a constant linear velocity corresponding to 2× speed; rᵢ, the radial width of the spare area on the innermost circumference side of the optical disk 100; rₒ, the radial width of the spare area on the outermost circumference side of the optical disk 100; rᵢ₁, a radially innermost position of the spare area on the disk innermost circumference side; rᵢ₂, a radially outermost position of the spare area on the disk innermost circumference side; rₒ₁, a radially innermost position of the spare area on the disk outermost circumference side; rₒ₂, a radially outermost position of the spare area on the disk outermost circumference side; P and P′, the locations of detected defective blocks; r₁, the disk radial position of the defective block detected at location P in the user data recording area; r₂, the disk radial position of the defective block detected at location P′ in the user data recording area; r₃, the disk radial position of the block area in the spare area on the disk innermost circumference side to which user data is written instead of to the defective blocks; ω₁, the rotational speed of the optical disk 100 for the disk radial position r₁ when user data is written at 5× speed; ω₂, the rotational speed of the optical disk 100 for the disk radial position r₂ when user data is written at 5× speed; ω₃, the rotational speed of the optical disk 100 for the disk radial position r₃ when user data is written at 2× speed; and ω₄, the rotational speed of the optical disk 100 for the disk radial position r₃ when user data is written at 5× speed.

Referring to FIGS. 2(A) and 2(B), when the disk apparatus is writing user data to the user data recording area at 5× speed, if it detects a defective block at location P to which it is difficult to properly write user data, the microprocessor 500 within the disk apparatus starts a control operation for a (block) replacement process based on the detection result. That is, the microprocessor 500 detects the rotational speed ω₁ of the optical disk 100 for the disk radial position r₁ of the defective block detected at location P, and determines whether the rotational speed ω₁ falls within the standard speed range (ω₃-ω₄) set for the disk radial position r₃ of the block area in a target spare area (in this example, the spare area on the disk innermost circumference side) to which the address of the defective block is to be assigned. At that time, to assign the address of the defective block to the block area (at the disk radial position r₃) in the spare area, the microprocessor 500 writes system management information to the management area. The system management information indicates that the user data should be written to (the block area in) the spare area instead of the defective block. The microprocessor 500 then selects a speed from within the above standard speed range based on the above determination result and sets it as the rotational speed of the optical disk 100 for the spare area. That is, as shown in FIGS. 2(A) and 2(B), since the determination result indicates that the rotational speed ω₁ of the optical disk 100 set for the disk radial position r₁ of the defective block detected at location P falls within the standard speed range (ω₃-ω₄) set for the disk radial position r₃ of the block area in the spare area to which the address of the defective block is assigned (that is, ω₃<ω₁<ω₄), the microprocessor 500 sets the rotational speed ω₁ of the optical disk 100 set for the disk radial position r₁ of the defective block as the rotational speed of the optical disk 100 for the spare area. Furthermore, the microprocessor 500 moves the optical pickup 200 to the spare area on the disk innermost circumference side, rotates the optical disk 100 at the rotational speed ω₁ set for the spare area, and writes the user data to the block area at the disk radial position r₃ in the spare area. That is, the disk apparatus switches to the write operation in the spare area without changing the rotational speed of the optical disk 100. Upon completion of the user data write operation in the spare area, the microprocessor 500 moves the optical pickup 200 from the spare area to the disk radial position of the block next to the defective block in the user data recording area, and rotates the optical disk 100 at the rotational speed corresponding to the disk radial position. In this rotational state, the microprocessor 500 writes user data to the above next block by use of the optical pickup 200.

On the other hand, still referring to FIGS. 2(A) and 2(B), when the optical disk apparatus is writing user data to the user data recording area at 5× speed, if it detects a defective block at location P′ to which it is difficult to properly write user data, the microprocessor 500 within the disk apparatus also starts a control operation for a (block) replacement process based on the detection result. That is, the microprocessor 500 detects the rotational speed ω₂ of the optical disk for the disk radial position r₂ of the defective block detected at location P′, and determines whether the rotational speed ω₂ falls within the standard speed range (ω₃-ω₄) set for the disk radial position r₃ of the block area in a target spare area (in this example, the spare area on the disk innermost circumference side) to which the address of the defective block is to be assigned. At that time, to assign the address of the defective block to the block area (at the disk radial position r₃) in the spare area, the microprocessor 500 writes system management information to the management area. The system management information indicates that the user data should be written to (the block area in) the spare area instead of to the defective block.

The microprocessor 500 then selects a speed from within the above standard speed range based on the above determination result and sets it as the rotational speed of the optical disk 100 for the spare area. That is, as shown in FIGS. 2(A) and 2(B), since the determination result indicates that the rotational speed ω₂ of the optical disk 100 set for the disk radial position r₂ of the defective block detected at location P′ does not fall within the standard speed range (ω₃-ω₄) set for the disk radial position r₃ of the block area in the spare area to which the address of the defective block is assigned (that is, ω₂<ω₃<ω₄), the microprocessor 500 sets the rotational speed ω₃ of the optical disk 100 (which is higher than the rotational speed ω₂ of the optical disk 100 for the disk radial position r₂ of the defective block) as the rotational speed of the optical disk 100 for the spare area. The rotational speed ω₃ is the closest rotational speed within the standard speed range (ω₃-ω₄) to the rotational speed ω₂. Further, the microprocessor 500 moves the optical pickup 200 to the spare area on the innermost circumference side, rotates the optical disk 100 at the rotational speed ω₃ set for the spare area, and writes the user data to the block area at the disk radial position r₃ in the spare area. That is, the disk apparatus switches to the write operation in the spare area after increasing the rotational speed of the optical disk 100 from ω₂ to ω₃. Upon completion of the user data write operation in the spare area, the microprocessor 500 moves the optical pickup 200 from the spare area to the disk radial position of the block next to the defective block in the user data recording area, and rotates the optical disk 100 at the rotational speed corresponding to the disk radial position. In this rotational state of the optical disk 100, the microprocessor 500 writes user data to the above next block by use of the optical pickup 200.

In the above example, user data is written to the spare area on the disk innermost circumference side instead of to a defective block in the user data recording area. On the other hand, when user data is written to the spare area on the outermost circumference side, the microprocessor 500 sets the rotational speed ω₆ as the rotation speed of the optical disk 100 for the spare area. (The rotational speed ω₆ is lower than the rotational speed ω₁ of the optical disk 100 set for the disk radial position r₁ of the defective block at location P and also lower than the rotational speed ω₂ of the optical disk 100 set for the disk radial position r₂ of the defective block at location P′, as shown in FIGS. 2(A) and 2(B).) The rotational speed ω₆ is the closest rotational speed within the standard speed range (ω₅-ω₆) to the rotational speeds ω₁ and ω₂. The microprocessor 500 rotates the optical disk 100 at the rotational speed ω₆ set for the spare area, and writes the user data to the block area at the disk radial position r₅ in the spare area. That is, the disk apparatus performs the write operation in the spare area after decreasing the rotational speed of the optical disk 100 from ω₁ or ω₂ to ω₆.

In the example shown in FIGS. 2(A) and 2(B) described above, information (user data) is written to a disk. It should be noted that though not illustrated, reading the written information from the disk requires, basically the same disk rotation control as the write operation.

FIG. 3 is a flowchart illustrating a (block) replacement process in the optical disk apparatus shown in FIG. 1.

The process includes the following steps.

(1) First, user data is written to a block(s) in the user data recording area (step S301). (A block is a minimum unit in which user data is written.) Then, the microprocessor 500 immediately reads the above block (step S302), and determines whether the read data is identical to the written data (step S303). If it is determined that the read data is not identical to the written data, the microprocessor 500 determines that the block is a defective block and causes the disk apparatus to initiate a (block) replacement process by issuing an instruction signal based on the determination result.

(2) The microprocessor 500 determines (detects) the rotational speed of the optical disk 100 set for the disk radial position of the detected defective block (step S304).

(3) The microprocessor 500 determines whether the determined disk rotational speed falls within the standard speed range set for the disk radial position of the block area in a target spare area to which the address of the defective block is assigned (step S305).

(4) If it is determined that the determined disk rotational speed falls within the standard speed range, the microprocessor 500 sets the determined disk rotational speed (i.e., the disk rotational speed of the optical disk 100 set for the disk radial position of the defective block) as the rotational speed of the optical disk 100 for the spare area without changing it (step S306).

If, on the other hand, it is determined that the determined disk rotational speed does not fall within the standard speed range, the microprocessor 500 selects a rotational speed from within the standard speed range which is higher than the determined disk rotational speed (that is, the rotational speed of the optical disk 100 set for the disk radial position of the defective block) and sets it as the rotational speed of the optical disk 100 for the spare area (step S307) Specifically, the microprocessor 500 selects the rotational speed within the standard speed range closest to the determined rotational speed in order to reduce the change in the rotational speed of the optical disk 100 (during the block replacement process).

(5) The microprocessor 500 controls the slide motor drive circuit 330 to move the optical pickup 200 to the spare area by use of the slide motor 320 (step S308).

(6) The microprocessor 500 controls the focus/tracking control circuit 220 to perform a focus/tracking control of the objective lens by use of the actuator (not shown) within the optical pickup 200 (step S309).

(7) The microprocessor 500 controls the write signal generating circuit 420 and causes the laser drive circuit 430 to drive the laser diode within the optical pickup 200 so as to write user data to (a block in the block area in) the spare area (step S310).

(8) Upon completion of the user data write operation to the block in the spare area, the microprocessor 500 reads the block (step S311), and compares the read data with the written data (step S312). If the read data is not identical to the written data, the process returns to step S304 (described in item (2) above) at which the next block in the spare area is set as a target block. This cycle is repeated until a nondefective block is found.

(9) Upon successful completion of the user data write operation to a block in the spare area, the microprocessor 500 controls the slide motor drive circuit 330 to move the optical pickup 200 from the spare area to the disk radial position of the block next to the defective block in the user data recording area, and rotates the optical disk 100 at the rotational speed corresponding to the disk radial position (step S313).

(10) The microprocessor 500 causes the focus/tracking control circuit 220 to perform a focus/tracking control in the user data recording area (step S314).

(11) The microprocessor 500 performs control so as to write user data to the block next to the defective block in the user data recording area (step S315). Referring back to step S303 described in item (1) above, if it is determined that the read data is identical to the written data, the process proceeds directly to step S315 at which the microprocessor 500 locates the next block in the user data recording area. Then, the process returns to step S301, and this and subsequent steps are performed.

The present embodiment provides an optical disk apparatus capable of reducing the change in the disk rotational speed during a (block) replacement process, ensuring that each (block) replacement operation can be quickly initiated.

Even though the above embodiment was described as applied to an optical disk apparatus, the present invention is not limited to this particular type of disk apparatus. The present invention may be applied to other types of disk apparatuses.

1. A disk apparatus for writing/reading information to/from a disk using a defective block replacement process, said disk apparatus comprising:
a disk motor for rotating said disk;
disk motor driving circuit for driving said disk motor; and
control circuit for, in said (block) replacement process, performing the steps of:
determining whether the rotational speed of said disk set for the disk radial position of a defective block in a user data recording area falls within a standard speed range set for a disk radial position in a spare area (a block is a minimum unit in which user data is written or read);
based on the result of said determination, selecting a speed from within said standard speed range and setting it as the rotational speed of said disk for said spare area; and
based on the result of said setting, controlling said disk motor driving circuit;
wherein said control circuit selects said speed from within said standard speed range in such a way as to reduce the difference between said rotational speed of said disk set for said spare area and said rotational speed (of said disk set for said disk radial position of said defective block) in said user data recording area.

2. The disk apparatus as claimed in claim 1, wherein if said result of said determination indicates that said rotational speed of said disk set for said disk radial position of said defective block falls within said standard speed range, said control circuit sets said rotational speed of said disk set for said disk radial position of said defective block as said rotational speed of said disk for said spare area.

3. The disk apparatus as claimed in claim 1 or 2, wherein if said result of said determination indicates that said rotational speed of said disk set for said disk radial position of said defective block does not fall within said standard speed range, said control circuit selects either the highest or lowest speed within said standard speed range and sets it as said rotational speed of said disk for said spare area.

4. A method for writing or reading information (or user data) in a disk apparatus using a (block) replacement process, said method comprising:
a first step of checking blocks in a user data recording area of a disk for defects;
a second step of, if a defective block has been detected, determining whether the rotational speed of said disk set for the disk radial position of said defective block falls within a standard speed range set for a disk radial position in a spare area beforehand, and assigning the address of said defective block to said spare area;
a third step of, based on the result of said determination, selecting a speed from within said standard speed range and setting it as the rotational speed of said disk for said spare area;
rotating said disk at said set rotational speed (for said spare area) and writing/reading user data to/from said address assigned to said spare area; and
writing/reading user data to/from a block next to said defective block.

5. A method for controlling the rotational speed of a disk in a disk apparatus which writes/reads information (or user data) to/from said disk using a (block) replacement process, said method comprising:
a first step of checking blocks in a user data recording area of said disk for defects;
a second step of, if a defective block has been detected, determining whether the rotational speed of said disk set for the disk radial position of said defective block falls within a standard speed range set for a disk radial position in a spare area beforehand; and
a third step of, based on the result of said determination, selecting a speed from within said standard speed range and setting it as the rotational speed of said disk for said spare area;
wherein said first to third steps are performed to control the rotational speed of said disk in said (block) replacement process.

6. The method as claimed in claim 5., wherein said third step includes steps of:
if said result of said determination indicates that said rotational speed of said disk set for said disk radial position of said defective block falls within said standard speed range, setting said rotational speed of said disk set for said disk radial position of said defective block as said rotational speed of said disk for said spare area; and
if said result of said determination indicates that said rotational speed of said disk set for said disk radial position of said defective block does not fall within said standard speed range, selecting either the highest or lowest speed within said standard speed range and setting it as said rotational speed of said disk for said spare area.
